(19) United States
(12) Patent Application Publication
(10) Pub. No.: US 2011/0252152 A1
(43) Pub. Date: Oct. 13, 2011

(54) RELIABLE MESSAGING SYSTEM AND METHOD

(76) Inventors: Marcus Sherry, San Francisco, CA (US); Nikola Borisov, Palo Alto, CA (US); Ralph Harik, Palo Alto, CA (US); Georges Harik, Palo Alto, CA (US)

(21) Appl. No.: 13/082,272

(22) Filed: Apr. 7, 2011

Related U.S. Application Data
(60) Provisional application No. 61/322,781, filed on Apr. 9, 2010.

(51) Int. Cl. G06F 15/16

(52) U.S. Cl. 709/228

(57) ABSTRACT

A reliable messaging channel is created using multiple independent HTTP requests. In one embodiment, a method (a) establishes a session identifier by exchanging messages with a recipient using an application layer communication protocol (e.g., HTTP); and (b) uses the application layer communication protocol to send ordered data to the recipient by assigning one or more sequence numbers according to the predetermined order in the data. The session identifier may be generated, for example, using a random number of generator. In one implementation, the session identifier is not less than 96 bits long. The sender may receive from the recipient acknowledgements each acknowledging receipt of the data bearing a corresponding sequence number. Data to be sent in the opposite direction may piggy-back on an acknowledgement by including the data in a non-zero length payload. Data received out of order are queued. The sender may limit the rate at which data is transmitted to a “window size” (i.e., no more than a predetermined amount of data is sent within a predetermined time period). The window size is adjusted according to a channel condition (e.g., an amount of data retransmitted or lost during the predetermined time period). In one implementation, the window size is adjusted by doubling or halving, consistent with the channel condition.

### CROSS REFERENCE TO RELATED APPLICATIONS

The present application is related to and claims priority of copending U.S. provisional patent application (“Copending Provisional Application”), Ser. No. 61/322,781, entitled “RELIABLE MESSAGING SYSTEM AND METHOD,” filed on Apr. 9, 2010. The Copending Provisional Application is hereby incorporated by reference in its entirety.

### BACKGROUND OF THE INVENTION

1. Field of the Invention

The present invention relates to computer networks. In particular, the present invention relates to a reliable messaging system which can be used for communication in a computer network.

2. Discussion of the Related Art

In communication services on the computer networks, there are essentially two types of networking transport protocols : connection-oriented protocols (also know as “stream” type protocols) and connectionless (also known as “datagram” type protocols). Transport control protocol (TCP) is an example of a stream protocol, and user datagram protocol (UDP), not surprisingly, is an example of the datagram type protocol. Stream protocols attempt to guarantee in-order delivery of messages sent. Thus, to fulfill the guarantee, a stream protocol retransmits and re-orders messages in a manner transparent to higher-level protocols. As datagram protocols make no such guarantees, a higher-level protocol may have to implement message retransmission and re-ordering if in-order delivery at its or an even higher protocol level is desired.

The hypertext transfer protocol (HTTP) is an application-layer protocol, which is typically viewed as at least one level higher than the transport layer protocols (e.g., TCP and UDP). In popular implementations, HTTP is usually—but not necessarily—carried over TCP. One common method of making interactive web applications passes messages from a client (e.g., a web browser) to a server using a HTTP POST or GET request, and keeps the HTTP connection open until the server has data to send back to the client. This process is sometimes called “long polling”. Logically, one may think of the process as a bidirectional stream of messages between the client and the server, with HTTP being used as the underlying transport protocol. However, such a process introduces unreliability because, although HTTP may be carried over a reliable protocol, a request from the client may fail for one or more reasons, and often is not retried by the browser. One reason for failure in an HTTP request is the temporarily unavailability of the server (e.g., a temporary loss of network connectivity), or an unexpected change of the client's IP address. Loss of network connectivity and a change in the client's IP address are problems frequently encountered in a mobile device (e.g., a cell phone moving between base stations), or at a locations with poor network infrastructure. As a result, HTTP may be considered an unreliable transport protocol that requires a higher-level protocol to implement message retransmission and re-ordering.

### SUMMARY OF THE INVENTION

According to one embodiment of the present invention, a system creates a reliable messaging channel using multiple independent HTTP requests. Such a system is resilient to network problems.

A method of the present invention provides an application level stream protocol by (a) establishing a session identifier by exchanging messages with a recipient using an application layer communication protocol (e.g., HTTP); and (b) using the application layer communication protocol and the session identifier, sending ordered data to the recipient by including in the transmission one or more sequence numbers, wherein the sequence numbers are assigned according to the predetermined order in the data. The session identifier may be generated, for example, using a random number generator. In one implementation, the session identifier is not less than 96 bits long.

A method of the present invention may receive from the recipient acknowledgements each acknowledging receipt of data bearing a corresponding sequence number or sequence numbers. Data to be sent in the reversed direction may piggy-back on an acknowledgement by including data in a non-zero length payload. In one implementation, the sequence number in an acknowledgement indicates the next sequence number in the predetermined order the recipient expects to receive.

A method of the present invention may queue data received out of order in a queue.

A method of the present invention may limit the rate at which data is transmitted to a “window size” (i.e., no more than a predetermined amount of data is sent within a predetermined time period). The window size is adjusted according to a channel condition (e.g., an amount of data retransmitted or lost during the predetermined time period). In one implementation, the window size is adjusted by doubling or halving, consistent with the channel condition.

The present invention is better understood upon consideration of the detailed description below in conjunction with the drawings.

### BRIEF DESCRIPTION OF THE DRAWINGS

FIG. 1 illustrates communication in a reliable messaging channel that is built on top of multiple independent HTTP requests, in accordance with one embodiment of the present invention.

### DETAILED DESCRIPTION OF THE PREFERRED EMBODIMENTS

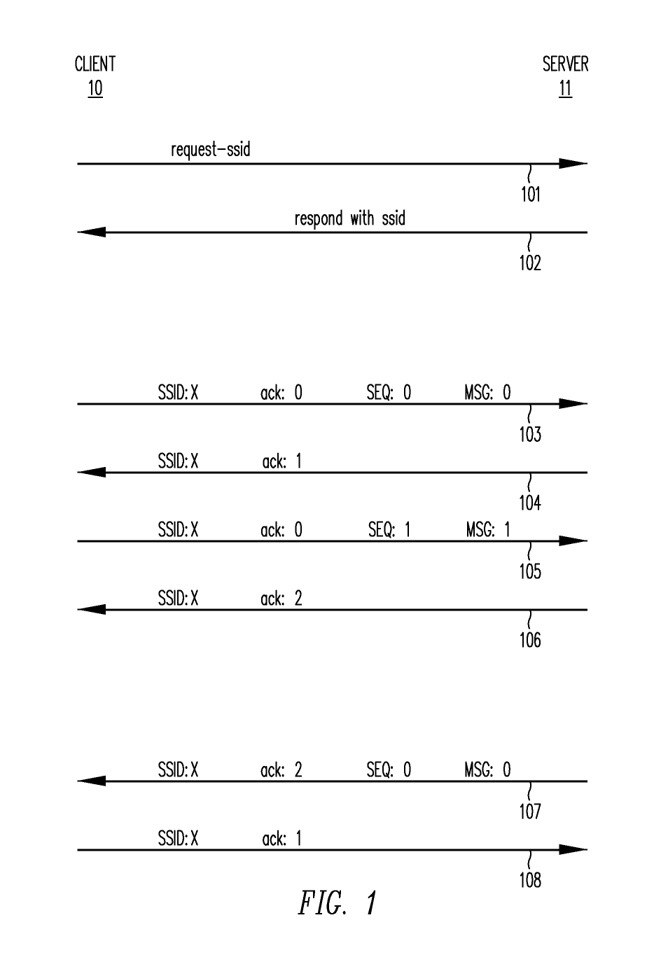

The present invention provides a method that guarantees in-order delivery of messages between a client and a server using HTTP as an underlying transport protocol (i.e., messages are sent from a client to a server in the body of an HTTP request, while messages from the server to the client may be sent over the body of a response to the HTTP request). Such a system may create a connection when sending a message to a server, or sends a message to the client using a connection that is created to listen for a message from the server. In general, however, a party to the communication can be both a client and a server at the same time. That is, when the party sends an HTTP request, it acts as a client, and when a party responds to an HTTP request, the party acts as the server. Such a system is resilient to various HTTP request failures, such as a network failure, temporary server unavailability, or an unexpected IP address change. FIG. 1 illustrates communication in such a reliable messaging channel that is built on top of multiple independent HTTP requests, in accordance with one embodiment of the present invention.

As shown in FIG. 1, as indicated by reference numeral 101, a connection-based channel at the application level may be created between client 10 and server 11 by client 10 sending a “request_ssid” message over an HTTP request (“request session identification” request). Upon receiving such a request, server 11 returns a unique identifier as the requested “ssid” (as indicated by reference numeral 102,), which is used by both client 10 and server 11 to identify to each other across multiple HTTP requests. This identifier, referred in this detailed description interchangeably as “session identifier”, or “ssid”, may be randomly selected or generated by client 10 (e.g., from a large enough pool as to make collisions with other clients statistically unlikely), or may be assigned to the client by the server 11 (as shown in FIG. 1). In one embodiment, server 11 generates a 96-bit ssid using a conventional random number generator. The ssid is used by client 10 exclusively with server 11 (i.e., in the logical sense, as server 11 may be implemented, for example, by one or more physical hosts behind a load balancer). Therefore, the ssid identifies a connection between server 11 and client 10. The ssid is used between server 11 and client 10 until the session is completed, or after a predetermined period of idle time elapsed (i.e., no HTTP level requests or responses are exchanged for a predetermined time period).

To ensure an in-order, reliable message delivery, messages in each HTTP request in each direction (i.e., from client 10 to server 11, or from server 11 to client 10) is identified by a unique number (“sequence number”). After the ssid is created by the communications indicated by reference numerals 101 and 102, using the ssid, client 10 sends to server 11 a first HTTP request with a null message array. The message array is a data structure in the body of the HTTP request (“payload”) that is intended for including any message or messages to the receiving party. This first HTTP request creates a “long polling” connection that allows server 11 to send messages to client 10. During the remainder of the application session, if client 10 detects that this long polling connection is closed, an HTTP request is sent by client 10 to reopen the long polling connection.

Referring back to FIG. 1, when client 10 has a message for server 11, an HTTP request with the message included in the message array is sent to server 11. Each message is provided a sequence number. For example, as indicated by reference numeral 103 in FIG. 1, a message (sequence number 0) is sent to server 11 using the ssid “x”. (The HTTP request contains in its payload (i.e., the message array shown as the “MSG” field) a message of non-zero length, indicated by the character “0”). Note that in this HTTP request, an acknowledgement field (i.e., “Ack”) has the value “0”, signaling to server 11 that client 10 is expecting message sequence number 0 from server 11. This HTTP request opens a second connection independent of the long polling connection described above. In one embodiment of the present invention, HTTP requests from client 10 to server 11 are tracked by one set of sequence numbers, and messages going the opposite direction (i.e., from server 11 to client 10) are tracked by another independent set of sequence numbers. Sequence numbers may start at an arbitrary number (e.g., zero is a convenient choice, but client 10 and server 11 may agree on any suitable initial sequence number to use). As seen in FIG. 1, the ranges of sequence numbers between client 10 and server 11 may overlap. Preferably, for each set of sequence numbers, the sequence number is incremented by one for each message in HTTP requests sent to the other party. In other words, if an HTTP request includes more than one message in the message array, each message would cause the sequence number in the next message to increase by one.

In response to the sequence number 0 message in the HTTP request, server 11 sends an acknowledgement, indicated by reference numeral 104, setting the value in the “Ack” field to “1,” thereby signaling to client 10 that server 11 expects a message in the next HTTP request to have sequence number “1,” and closing out the connection of the second HTTP request under ssid “x”. For example, as indicated by reference numeral 105, a message provided in client 10′s next HTTP request has sequence number “1.” (In this case, as shown in FIG. 1, the payload of the HTTP request provides a non-zero length message of sequence number “1” in the message array or “MSG” field). Again, this HTTP request opens a separate connection apart from the long polling connection. Note also that client 10′s HTTP request has the “Ack” field remains set at “0,” as no HTTP request bearing sequence number “0” or higher has been received from server 11. In response to client 10′s HTTP request (i.e., the request that contains the message with sequence number “1”), server 11 sends an acknowledgement, setting the “Ack” field in its response to “2” to indicate that it expects the next HTTP request message from client 10 to have a sequence number of “2.”

When server 11 has a message to send to client 10, server 11 may include the message in a response to the HTTP request in the long polling connection, or may piggy-back the message in an acknowledgement to the HTTP request in the separate connection. For example, as indicated by reference numeral 107, server 11 may respond to the HTTP request in the long polling connection, including the message (assigned sequence number “0”) in the message array. As shown in FIG. 1, this response to the HTTP request in the long polling connection includes an “Ack” field, which remains set at “2”. In response, as indicated by reference numeral 108, client 10 sends an acknowledgement in an HTTP request with the “Ack” field set to “1,” thereby reopening the long polling connection for subsequent messages from server 11.

According to one embodiment of the present invention, a sender may wait for an acknowledgement of an HTTP request from the recipient before sending the next HTTP request. In one embodiment of the present invention, a server delivers messages to each of multiple associated clients using HTTP requests. One application that may take advantage of the present invention may be, for example, an instant messaging application. The payload in each HTTP request may include one or more instant messages (assigned consecutive sequence numbers) for the intended recipient. In that application, the server maintains a queue of a client's instant messages for transmission. A copy of each transmitted message is kept until an acknowledgement is received for the message; at which time the copy of each acknowledged transmitted instant message may be marked for deletion. At any given time, there can be any number of queued client messages awaiting for transmission using the HTTP request mechanism of the present invention.

The client and the server each keep track of the sequence numbers used in messages in the HTTP requests it has already received from the other party. This may be accomplished by keeping track of the highest in-order sequence number seen so far (“last incoming sequence number”). In general, when a HTTP request message is received having a message bearing a sequence number that is greater than the last incoming sequence number, the message in the HTTP request is deemed “potentially valid”. If, however, the sequence number of the incoming message is less than or equal to the last incoming sequence number, that message in the HTTP request is deemed “invalid”, under the assumption that the incoming message is a duplicate of a message that has already been received. An invalid message is discarded.

Potentially valid messages are sorted and placed in a queue in order. Sorting messages allow an application receiving the messages receives them in the intended order, regardless of the actual order in which the messages are received. If the sequence number of the message at the head of the queue immediately follows the last incoming sequence number, that message may be removed from the queue immediately and processed as a valid or accepted incoming message. At that time, the last incoming sequence number is updated to reflect the sequence number of the delivered message. Otherwise, if the sequence number of the message at the head of the queue is greater than the last incoming message by more than one, one or more messages bearing sequence numbers between the last incoming sequence number and the sequence number of the message at the head of the queue are presumed delayed or lost, and no further action is taken at this time.

The acknowledgement protocol described above allows a sender of an HTTP request to inform the other party of the HTTP request the messages it has received using the protocol, so that messages delayed or lost in transit can be retransmitted. As explained above, the “Ack” field of an HTTP request message contains a value equal to the last incoming sequence number seen by the recipient plus one, indicating that all messages up to and including the acknowledged HTTP request message have been received.

As described above, when a party (i.e., either the client or the server) receives an incoming message in an HTTP request from the other party, while having its own outgoing messages to send to the other party, the recipient may piggy-back the outgoing messages in an acknowledgement (i.e., the response to the HTTP request may contain the outgoing messages in the payload, with the acknowledgment field set to the appropriate value). If the recipient has no outgoing message currently pending for the sender, the recipient may either immediately send an acknowledgement without a message payload (i.e., a null message array) to the sender, or wait the acknowledgement (up to a predetermined length of time) until an outgoing message is ready to be sent in the payload. When an acknowledgment has not been received for a message after a predetermined time, the sender may assume that the HTTP request failed in transit, and may therefore re-send it. A sender should retransmit a message at appropriate intervals until receiving a corresponding acknowledgment, so as to ensure that all messages reach their destinations.

To achieve efficient use of resources, the throughput of messages in HTTP requests may be controlled using a “windowing” technique. The windowing technique is particularly useful in situations of frequent loss of connectivity. Under the windowing technique, the sender limits the number of messages that can be sent in HTTP requests over a time period. That number of messages may be referred to as a “window” size. Based on the throughput condition (e.g., as measured by the number of unacknowledged messages or retransmitted messages over the time period), the window size may be adjusted accordingly. This technique automatically adjusts the data rate according to the channel condition, i.e., increasing the number of messages in attempted HTTP requests during good channel conditions, and reducing the number of messages in attempted HTTP requests during adverse channel conditions. In one embodiment, the window size is adjusted by either halving or doubling the current window size.

The above detailed description is provided to illustrate specific embodiments of the present invention and is not intended to be limiting. Numerous variations and modifications within the present invention are possible.

We claim:

1. A method for providing an application level stream protocol, comprising:
establishing a session identifier by exchanging messages with a recipient using an application layer communication protocol; and
using the application layer communication protocol, sending ordered data to the recipient, assigning one or more sequence numbers according to a predetermined order in the data.

2. The method of claim 1, wherein the session identifier is generated using a random number of generator.

3. The method of claim 1, wherein the session identifier is not less than 96 bits long.

4. The method of claim 1, wherein the application layer communication protocol comprises the hypertext transport protocol.

5. The method of claim 1, further comprising receiving from the recipient acknowledgements each acknowledging receipt of data bearing a corresponding sequence number.

6. The method of claim 5, wherein one or more of the acknowledgements include a non-zero length data payload.

7. The method of claim 5, wherein the sequence number in an acknowledgement indicates the next sequence number in the predetermined order the recipient expects to receive.

8. The method of claim 5, further comprising keeping a copy of data sent until the data is acknowledged in a corresponding acknowledgement received from the recipient.

9. The method of claim 5, further comprising maintaining a last incoming sequence number.

10. The method of claim 9 wherein, when a data packet is received having a sequence number which is next in the predetermined order from the last incoming sequence number, assigning the sequence number the last incoming sequence number.

11. The method of claim 9 further comprising, when packet is received associated with a sequence number which is earlier in the predetermined order than the last incoming sequence number, discarding the data.

12. The method of claim 9 further comprising, when a data packet is received having a sequence number which is later than the next in the predetermined order than the last incoming sequence number, keeping the data packet in a queue that arranges data packets consistent with the predetermined order.

13. The method of claim 1, further comprising retransmitting corresponding data upon receiving a retransmission request from the recipient.

14. The method of claim 5, further comprising retransmitting corresponding data after a predetermined time period from transmission without receiving a corresponding acknowledgement.

15. The method of claim 1, wherein no more than a predetermined amount of data is sent within a predetermined time period.

16. The method of claim 15, wherein the predetermined amount of data is adjusted according to a channel condition during the predetermined time period.

17. The method of claim 16, wherein the channel condition is an amount of data retransmitted or lost during the predetermined time period.

18. The method of claim 16, wherein the predetermined amount of data is adjusted by doubling or halving, consistent with the channel condition.
